(19) United States
(12) Patent Application Publication
(10) Pub. No.: US 2021/0205996 A1
(43) Pub. Date: Jul. 8, 2021

(54) LOCALIZATION OF ROBOT

(71) Applicant: LG ELECTRONICS INC., Seoul (KR)

(72) Inventors: Sookhyun YANG, Seoul (KR); Jungsik Kim, Seoul (KR); Gyuho Eoh, Seoul (KR)

(73) Assignee: LG ELECTRONICS INC.

(21) Appl. No.: 17/098,781

(22) Filed: Nov. 16, 2020

(30) Foreign Application Priority Data
Jan. 8, 2020 (KR) 10-2020-0002806

(51) Int. Cl. B25J 9/16

(52) U.S. Cl. CPC B25J 9/1697

(57) ABSTRACT

A robot according to one embodiment may include a storage configured to store a map of a space in which the robot operates, an input interface configured to obtain at least one image of a surrounding environment of the robot, and at least one processor configured to estimate a first position of the robot based on the at least one image obtained by the input interface, determine candidate nodes in the map of the space based on the first position of the robot, and estimate at least one of a second position of the robot or a pose of the robot based on the determined candidate nodes. In a 5G environment connected for the Internet of Things, embodiments may be implemented by executing an artificial intelligence algorithm and/or machine learning algorithm.

### CROSS-REFERENCE TO RELATED APPLICATION

This application claims benefit of priority to Korean Application No. 10-2020-0002806, filed Jan. 8, 2020, entitled “LOCALIZATION OF ROBOT,” the entire disclosure of which is incorporated herein by reference.

### BACKGROUND

### 1. Field

The present disclosure relates to a robot, and more particularly, to localization of a robot.

### 2. Background

Various robots that may be conveniently used in daily life have been actively developed. Such robots are used to help people in their daily places such as homes, schools, and other public places.

Mobile robots such as guide robots, delivery robots, and cleaning robots perform tasks while driving autonomously without manipulation of a user. In order for a robot to drive autonomously, localization of the robot is necessary. A current position of the robot may be recognized or re-recognized using a map of a space in which the robot operates, and various sensor data.

However, when an unexpected movement of the robot occurs, for example, the robot may be unable to properly recognize its current position or orientation. If the robot does not accurately recognize its current position or orientation, the robot may not be able to provide a service desired by the user.

Relocalization of the robot may be performed based on a similarity between features of images obtained by the robot and features of reference images. Such relocalization based on the images may be accomplished using a deep learning model such as PoseNet, for example. The related information is disclosed in PoseNet: A Convolutional Network for Real-Time 6-DOF Camera Relocalization, ICCV 2015, the subject matter of which is incorporated herein by reference.

However, when the position or the pose of the robot is estimated based on similarity of the features of the images, another position having a similar feature pattern may be estimated as the position of the robot. This may require performing a search over the entire map, thus requiring high processing performance. The relocalization based on the deep learning model may also deteriorate accuracy of the estimation.

### BRIEF DESCRIPTION OF THE DRAWINGS

Arrangements and embodiments may be described in detail with reference to the following drawings in which like reference numerals refer to like elements and wherein:

FIG. 1 is a diagram illustrating a robot system according to one embodiment of the present disclosure;

FIG. 2 is a diagram illustrating a configuration of an AI system according to one embodiment of the present disclosure;

FIG. 3 is a block diagram illustrating a configuration of a robot according to one embodiment of the present disclosure;

FIG. 4 is a diagram illustrating a map of a space according to one embodiment of the present disclosure;

FIG. 5 is a diagram illustrating coarse-grained estimation and fine-grained estimation according to one embodiment of the present disclosure; and

FIGS. 6A to 6C are flowcharts illustrating methods for localizing a robot according to one embodiment of the present disclosure.

### DETAILED DESCRIPTION

A robot may be a machine that automatically handles a given task by its own ability, or that operates autonomously. A robot having a function of recognizing an environment and performing an operation according to its own judgment may be referred to as an intelligent robot. The robot may be classified into industrial, medical, household, and military robot, according to the purpose or field of use.

The robot may include a driver including an actuator or a motor in order to perform various physical operations, such as moving joints of the robot. A movable robot may be equipped with a wheel, a brake, a propeller, and the like to drive on the ground or fly in the air. The robot may be provided with legs or feet to walk two-legged or four-legged on the ground.

Autonomous driving refers to a technology in which driving is performed autonomously, and an autonomous vehicle refers to a vehicle capable of driving without manipulation of a user or with minimal manipulation of a user. For example, autonomous driving may include all of a technology for keeping a driving lane, a technology for automatically controlling a speed such as adaptive cruise control, a technology for automatically driving a vehicle along a determined path, a technology for, if a destination is set, automatically setting a path and driving a vehicle along the path, and the like. A vehicle may include a vehicle having only an internal combustion engine, a hybrid vehicle having both an internal combustion engine and an electric motor, and an electric vehicle having only an electric motor, and may include not only an automobile but also a train, a motorcycle, and the like. The autonomous vehicle may be considered as a robot with an autonomous driving function.

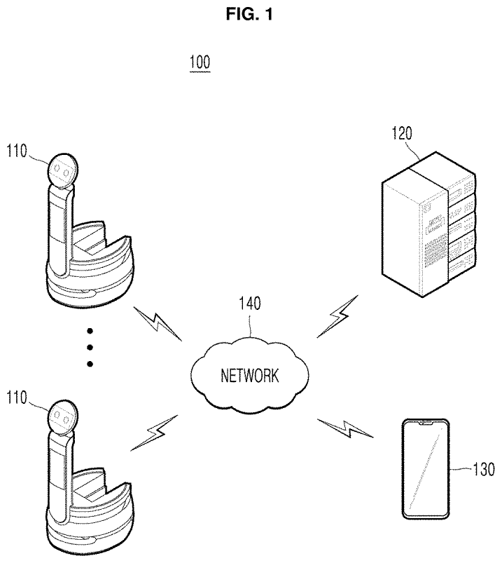

FIG. 1 is a diagram illustrating a robot system according to one embodiment of the present disclosure. The robot system may include one or more robots 110 and a control server 120, and may further include a terminal 130. The one or more robots 110, the control server 120, and the terminal 130 may be connected to each other via a network 140. The one or more robots 110, the control server 120, and the terminal 130 may communicate with each other via a base station, but may also communicate with each other directly without the base station.

The one or more robots 110 may perform a task in a space, and provide information or data related to the task to the control server 120. A workspace of the robot may be indoors or outdoors. The robot may operate in a space predefined by a wall, a column, and/or the like. The workspace of the robot may be defined in various ways according to the design purpose, working attributes of the robot, mobility of the robot, and other factors. The robot may operate in an open space that is not predefined. The robot may also sense a surrounding environment and determine the workspace by itself.

The one or more robots 110 may provide their state information or data to the control server 120. The state information of the robots 110 may include, for example, information on the robots 110, such as a position, a battery level, durability of parts, replacement cycles of consumables, and the like.

The control server 120 may perform various analysis based on information or data provided by the one or more robots 110, and control an overall operation of a robot system based on the analysis result. In one aspect, the control server 120 may directly control the driving of the robots 110 based on the analysis result. In another aspect, the control server 120 may derive and output useful information or data from the analysis result. In still another aspect, the control server 120 may adjust parameters in the robot system using the derived information or data. The control server 120 may be implemented as a single server, but may be implemented as a set of a plurality of servers, a cloud server, or a combination thereof.

The terminal 130 may share the role of the control server 120. In one aspect, the terminal 130 may obtain information or data from the one or more robots 110 and provide the obtained information or data to the control server 120. Alternatively, the terminal 130 may obtain information or data from the control server 120 and provide the obtained information or data to the one or more robots 110. In another aspect, the terminal 130 may be responsible for at least part of the analysis to be performed by the control server 120, and may provide the analysis result to the control server 120. In still another aspect, the terminal 130 may receive, from the control server 120, the analysis result, information, or data, and may simply output the received analysis result, information, or data.

The terminal 130 may take the place of the control server 120. At least one robot of the one or more robots 110 may take the place of the control server 120. In this example, the one or more robots 110 may be connected to communicate with each other.

The terminal 130 may include various electronic devices capable of communicating with the robots 110 and the control server 120. For example, the terminal 130 may be implemented as a stationary terminal and a mobile terminal, such as a mobile phone, a smartphone, a laptop computer, a terminal for digital broadcast, a personal digital assistant (PDA), a portable multimedia player (PMP), a navigation system, a slate PC, a tablet PC, an ultrabook, a wearable device (for example, a smartwatch, a smart glass, and a head-mounted display (HMD)), a set-top box (STB), a digital multimedia broadcast (DMB) receiver, a radio, a laundry machine, a refrigerator, a vacuum cleaner, an air conditioner, a desktop computer, a projector, and a digital signage.

The network 140 may refer to a network that configures a portion of a cloud computing infrastructure or exists in the cloud computing infrastructure. The network 140 may be, for example, a wired network such as local area networks (LANs), wide area networks (WANs), metropolitan area networks (MANs), or integrated service digital networks (ISDNs), or a wireless communications network such as wireless LANs, code division multi access (CDMA), Wideband CDMA (WCDMA), long term evolution (LTE), long term evolution-advanced (LTE-A), 5G (generation) communications, Bluetooth, or satellite communications, but is not limited thereto.

The network 140 may include a connection of network elements such as a hub, a bridge, a router, a switch, and a gateway. The network 140 may include one or more connected networks, for example, a multi-network environment, including a public network such as an Internet and a private network such as a safe corporate private network. Access to the network 140 may be provided through one or more wire-based or wireless access networks. The network 140 may support various types of Machine to Machine (M2M) communications, such as Internet of things (IoT), Internet of everything (IoE), and Internet of small things (IoST), and/or 5G communication, to exchange and process information between distributed components such as objects.

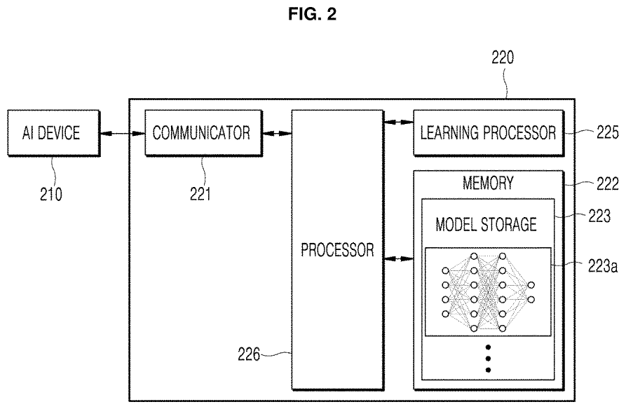

FIG. 2 is a diagram illustrating a configuration of an AI system according to one embodiment of the present disclosure. In an embodiment, a robot system may be implemented as an AI system capable of artificial intelligence and/or machine learning. Artificial intelligence refers to a field of studying artificial intelligence or a methodology for creating the same. Machine learning refers to a field of defining various problems dealing in an artificial intelligence field and studying methodologies for solving the same. The machine learning may be defined as an algorithm for improving performance with respect to any task through repeated experience with respect to the task.

An artificial neural network (ANN) is a model used in machine learning, and may refer to a model with problem-solving abilities, composed of artificial neurons (nodes) forming a network by a connection of synapses. The artificial neural network may be defined by a connection pattern between neurons on different layers, a learning process for updating model parameters, and an activation function for generating an output value.

The artificial neural network may include an input layer, an output layer, and/or optionally one or more hidden layers. Each layer may include one or more neurons, and the artificial neural network may include synapses that connect the neurons to one another. In the artificial neural network, each neuron may output a function value of an activation function with respect to the input signals inputted through a synapse, weight, and bias.

The model parameters refer to parameters determined through learning, and may include weights of synapse connection, bias of a neuron, and/or the like. A hyperparameters may refer to parameters which are set before learning in the machine learning algorithm, and may include a learning rate, a number of repetitions, a mini batch size, an initialization function, and the like.

The objective of training the artificial neural network is to determine a model parameter for significantly reducing a loss function. The loss function may be used as an indicator for determining an optimal model parameter in a learning process of the artificial neural network.

The machine learning may be classified into supervised learning, unsupervised learning, and reinforcement learning depending on the learning method. Supervised learning may refer to a method for training the artificial neural network with training data that has been given a label. The label may refer to a target answer (or a result value) to be inferred by the artificial neural network when the training data is inputted to the artificial neural network. Unsupervised learning may refer to a method for training the artificial neural network using training data that has not been given a label. Reinforcement learning may refer to a learning method for training an agent defined within an environment to select an action or an action order for maximizing cumulative rewards in each state.

Machine learning implemented as a deep neural network (DNN) including a plurality of hidden layers, among artificial neural networks may be referred to as deep learning and the deep learning is one machine learning technique. The meaning of machine learning may include deep learning.

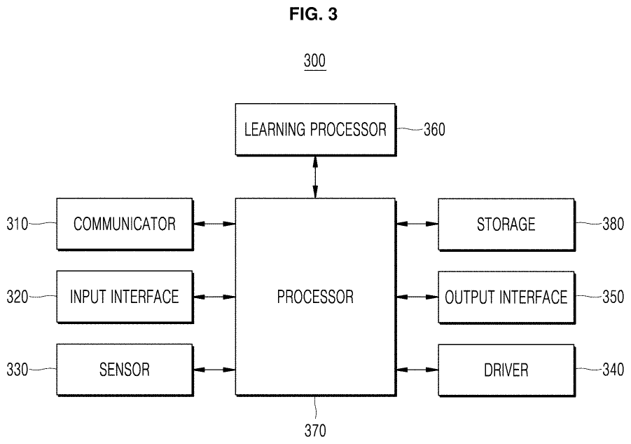

Referring to FIG. 2, the robot system according to one embodiment of the present disclosure may include an AI device 210 and an AI server 220. In an embodiment, the AI device 210 may be the robot 110, the control server 120, the terminal 130 of FIG. 1, or the robot 300 of FIG. 3. The AI server 220 may be the control server 120 of FIG. 1.

The AI server 220 may refer to a device for using a trained artificial neural network or training an artificial neural network using a machine learning algorithm. The AI server 220 may be composed of a plurality of servers to perform distributed processing. The AI server 220 may be included as a configuration of the AI device 210, thereby performing at least some of artificial intelligence and/or machine learning processing with the AI device 210.

The AI server 220 may include a communicator 221 (or communication device), a memory 222, a learning processor 225, a processor 226, and the like. The communicator 221 may transmit or receive data with an external device such as the AI device 210.

The memory 222 may include a model storage 223. The model storage 223 may store a model (or an artificial neural network 223a) that is being trained or was trained by the learning processor 225.

The learning processor 225 may train the artificial neural network 223a using training data. The trained model may be used while mounted in the AI server 220 of the artificial neural network, and/or may be used while mounted in the external device such as the AI device 210. The trained model may be implemented as hardware, software, or a combination of hardware and software. When a portion or all of the trained model is implemented as software, one or more instructions constituting the trained model may be stored in the memory 222. The processor 226 may infer a result value with respect to new input data using the trained model, and may generate a response or control command based on the inferred result value.

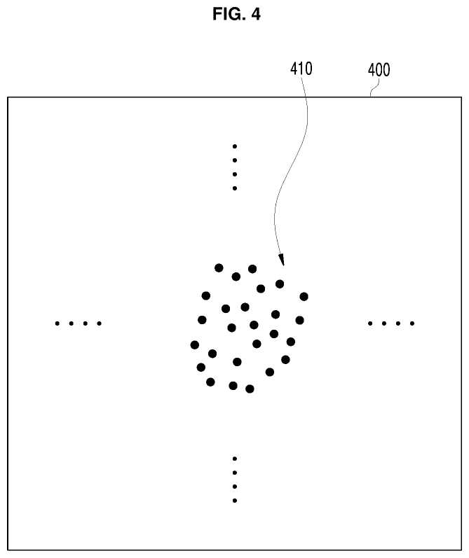

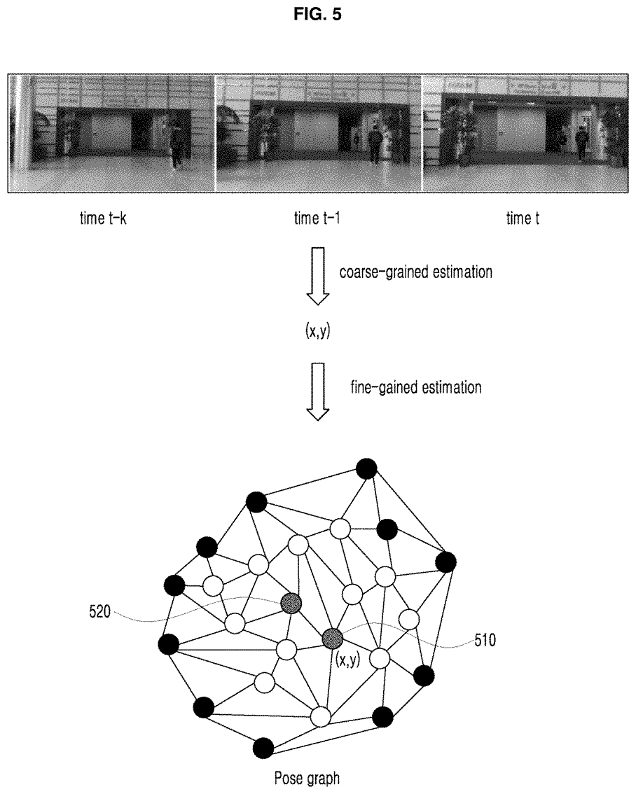

FIG. 3 is a block diagram illustrating a configuration of a robot according to one embodiment of the present disclosure. FIG. 4 is a diagram illustrating a map of a space (or area) according to one embodiment of the present disclosure. FIG. 5 is a diagram illustrating coarse-grained estimation and fine-grained estimation according to one embodiment of the present disclosure.

The robot may be unable to properly recognize its current position or orientation for various reasons. If the robot does not accurately recognize its current position or orientation, the robot may not be able to provide a service desired by the user.

Embodiments of the present disclosure may provide methods for enabling the robot to accurately recognize its position or pose by using two-stage estimations of coarse-grained estimation and fine-grained estimation. In the present disclosure, the ‘position’ of the robot may represent two-dimensional coordinate information (x, y) of the robot, and the ‘pose’ of the robot may represent two-dimensional coordinate information and orientation information (x, y, θ).

Referring to FIG. 3, the robot 300 according to one embodiment may include a communicator 310 (or a communication device), an input interface 320 (or input device), a sensor 330, a driver 340, an output interface 350 (or output device), a processor 370, and a storage 380 (or a memory). The robot 300 may further include a learning processor 360 configured to perform operations related to artificial intelligence and/or machine learning.

The communicator 310 may transmit or receive information or data with external devices such as the control server 120 or the terminal 130 using wired or wireless communication technology. The communicator 310 may transmit or receive sensor information, a user input, a trained model, a control signal, and the like with the external devices. The communicator 310 may include a communicator for transmitting or receiving data, such as a receiver, a transmitter, or a transceiver.

The communicator 310 may use communication technology such as global system for mobile communication (GSM), code division multi access (CDMA), CDMA2000, enhanced voice-data optimized or enhanced voice-data only (EV-DO), wideband CDMA (WCDMA), high speed downlink packet access (HSDPA), high speed uplink packet access (HSUPA), long term evolution (LTE), LTE-advanced (LTE-A), wireless LAN (WLAN), wireless-fidelity (Wi-Fi), Bluetooth™, radio frequency identification (RFID), infrared data association (IrDA), ZigBee, near field communication (NFC), visible light communication, and light-fidelity (Li-Fi).

The communicator 310 may use a 5G communication network. The communicator 310 may communicate with external devices such as the control server 120 and the terminal 130 by using at least one service of enhanced mobile broadband (eMBB), ultra-reliable and low latency communication (URLLC), or massive machine-type communication (mMTC).

The eMBB is a mobile broadband service, through which multimedia content, wireless data access, and the like are provided. Improved mobile services such as hotspots and broadband coverage for accommodating the rapidly growing mobile traffic may be provided via eMBB. Through a hotspot, high-volume traffic may be accommodated in an area where user mobility is low and user density is high. Through broadband coverage, a wide-range and stable wireless environment and user mobility may be guaranteed.

The URLLC service defines requirements that are far more stringent than existing LTE in terms of transmission delay and reliability of data transmission or reception. Based on such services, 5G services may be provided for, for example, production process automation at industrial sites, telemedicine, telesurgery, transportation, and safety.

The mMTC is a transmission delay-insensitive service that requires a relatively small amount of data transmission. The mMTC enables a much larger number of terminals to access the wireless access networks simultaneously than before.

The communicator 310 may receive a map of a space (or area) in which the robot 110 (or robots) operate, from the control server 120, the terminal 130, and/or another robot. For example, as shown in FIG. 4, the map of the space may include a pose graph 410 that includes a plurality of nodes in the space 400. The map of the space may optionally include reference images corresponding to each node in the pose graph 410. Each node in the pose graph 410 may indicate a position or a pose in the space 400. The communicator 310 may provide the received map of the space to the processor 370. The map of the space may be stored in the storage 380.

The communicator 310 may receive a trained model from the control server 120, the terminal 130, and/or another robot. The communicator 310 may provide the received trained model to the processor 370 or the learning processor 360. The trained model may be stored in the storage 380.

The input interface 320 may obtain various types of data. The input interface 320 may include at least one camera for obtaining an image signal including an image or a video image, a microphone for obtaining an audio signal, a user interface for receiving information from a user, and/or the like.

The input interface 320 may obtain images of a surrounding environment of the robot 300 by the at least one camera. The at least one camera may obtain a plurality of consecutive sequential images in the same position and/or in the same orientation. The images obtained by the at least one camera may be provided to the processor 370 or the learning processor 360. The camera may include a 180° camera or a 360° camera, for example.

The input interface 320 may receive information on the above-described map of the space, through a user interface. That is, the map of the space may be inputted from the user through the input interface 320.

The input interface 320 may obtain (or receive) training data for training the artificial neural network, input data to be used when obtaining the output using the trained model, and/or the like. The input interface 320 may obtain raw input data. The processor 370 or the learning processor 360 may extract an input feature by preprocessing the input data.

The sensor 330 may obtain (or receive) at least one of internal information of the robot 300, surrounding environment information, or user information by using various sensors. The sensor 330 may include an acceleration sensor, a magnetic sensor, a gyroscope sensor, an inertial sensor, a proximity sensor, an RGB sensor, an illumination sensor, a humidity sensor, a fingerprint recognition sensor, an ultrasonic sensor, a microphone, a Lidar sensor, a radar, or any combination thereof. The sensor data obtained by the sensor 330 may be used for autonomous driving of the robot 300 and/or for generating the map of the space.

The driver 340 may physically drive (or move) the robot 300. The driver 340 may include an actuator or a motor that operates according to a control signal from the processor 370. The driver 340 may include a wheel, a brake, a propeller, and the like, which are operated by the actuator or the motor.

The output interface 350 may generate an output related to visual, auditory, tactile and/or the like. The output interface 350 may include a display outputting visual information, a speaker outputting auditory information, a haptic module outputting tactile information, and the like.

The storage 380 (or memory) may store data supporting various functions of the robot 300. The storage 380 may store information or data received by the communicator 310, and input information, input data, training data, a trained model, a learning history, and the like, obtained by the input interface 320. The storage 380 may include a RAM memory, a flash memory, a ROM memory, an EPROM memory, an EEPROM memory, registers, a hard disk, and/or the like.

In an embodiment, the storage 380 may store the map of the space or the trained model received from the communicator 310 or the input interface 320, for example. The map of the space or the trained model may be received in advance from the control server 120 or the like and stored in the storage 380, and may be periodically updated.

The learning processor 360 may train a model composed of an artificial neural network using training data. The trained artificial neural network may be referred to as a trained model. The trained model may be used to infer a result value with respect to new input data rather than training data, and the inferred value may be used as a basis for judgment to perform an operation.

In an embodiment, the learning processor 360 may train the artificial neural network to output a position or a pose corresponding to a query image, using reference images and query images obtained by the input interface 320 as training data. In an embodiment, the learning processor 360 may determine the position or the pose corresponding to the query image, using the at least one query image obtained by the input interface 320 as input data for the trained model based on the artificial neural network.

The learning processor 360 may perform artificial intelligence and/or machine learning processing together with the learning processor 225 of the AI server 220 of FIG. 2. The learning processor 360 may include a memory integrated into or implemented in the robot 300. Alternatively, the learning processor 360 may also be implemented by using the storage 380, an external memory directly coupled to the robot 300, or a memory held in the external device.

The processor 370 may determine at least one executable operation of the robot 300, based on information determined or generated using a data analysis algorithm or a machine learning algorithm. The processor 370 may control components of the robot 300 to perform the determined operation.

The processor 370 may estimate a position or a pose of the robot 300 by using two-stage estimations of coarse-grained estimation and fine-grained estimation. The operation of the processor 370 will be described with reference to FIG. 5.

### Coarse-Grained Estimation

The processor 370 may estimate a coarse-grained position of the robot 300 based on at least one image obtained by the input interface 320. As shown in FIG. 5, the coarse-grained position 510 of the robot 300 may be represented by two-dimensional coordinate information (x, y) indicating the node 510 in a map of a space.

In an embodiment, the at least one image may include a plurality of consecutive sequential images. As shown in FIG. 5, the input interface 320 may only obtain an image at ‘time t.’ However, the input interface 320 may also obtain sequential images at ‘time t-k, . . . time t-1, time t.’

The coarse-grained position of the robot 300 may be estimated by a trained model based on an artificial neural network. The trained model may be trained to output a specific node in the map of the space or a specific position in the space, corresponding to the at least one image obtained by the input interface 320. The trained model may be implemented by deep learning. The trained model may be implemented by any one of trained models for relocalization, known to those skilled in the art, such as PoseNet, PoseNet+LSTM, PoseNet+Bi-LSTM, PoseSiamNet.

The trained model may be stored in the AI server 220. The processor 370 may transmit the at least one image obtained by the input interface 320 to the AI server 220 having the trained model. The trained model of the AI server 220 may output a specific node in the map of the space or a specific position in the space, corresponding to the at least one image. The processor 370 may obtain, from the AI server 220 through the communicator 310, the coarse-grained position estimated by the trained model of the AI server 220.

The trained model may be stored in the storage 380 of the robot 300. The processor 370 may receive the trained model from the AI server 220 through the communicator 310. The received trained model is stored in the storage 380. The processor 370 may estimate the coarse-grained position of the robot 300 by inputting the at least one image obtained by the input interface 320 to the trained model of the storage 380.

### Determination of Candidate Nodes

The processor 370 may determine candidate nodes in the map of the space based on the coarse-grained position of the robot 300. The processor 370 may determine, as candidate nodes, nodes around the coarse-grained position of the robot 300.

The processor 370 may determine, as the candidate nodes, nodes within a predetermined search radius from the coarse-grained position of the robot 300. Referring to FIG. 5, the processor 370 may determine, as the candidate nodes, nodes within the search radius (indicated by white nodes) from the node 510 indicating the coarse-grained position of the robot 300. A range of the search radius may be variously selected according to characteristics of the space or design purpose, for example. The range of the search radius may be stored in advance in the storage 380, but may also be received together with the coarse-grained position from the AI server 220. In another embodiment, the processor 370 may determine, as the candidate nodes, a predetermined number of nodes in order of distance closer to the coarse-grained position.

### Fine-Grained Estimation

The processor 370 may estimate at least one of a current position or a current pose of the robot 300 based on the determined candidate nodes. In an embodiment, the processor 370 may calculate a matching rate by comparing features of the at least one image obtained by the input interface 320 with features of reference images of each of the candidate nodes. The processor 370 may determine a candidate node having the highest matching rate, as a final node. A position or a pose of the final node may be estimated as the current position or the current pose of the robot 300. For example, in FIG. 5, a node 520 of the candidate nodes that has a highest matching rate may be estimated as the final node.

In an embodiment, in response to at least one image obtained by the input interface 320 including a plurality of consecutive sequential images, the processor 370 may calculate a cumulative matching rate by sequentially comparing features of the sequential images with features of the reference images of each of the candidate nodes. The processor 370 may determine, as the final node, a candidate node having the highest cumulative matching rate.

According to embodiments, the robot 300 may accurately recognize its position and its pose by using two-stage estimations of coarse-grained estimation and fine-grained estimation.

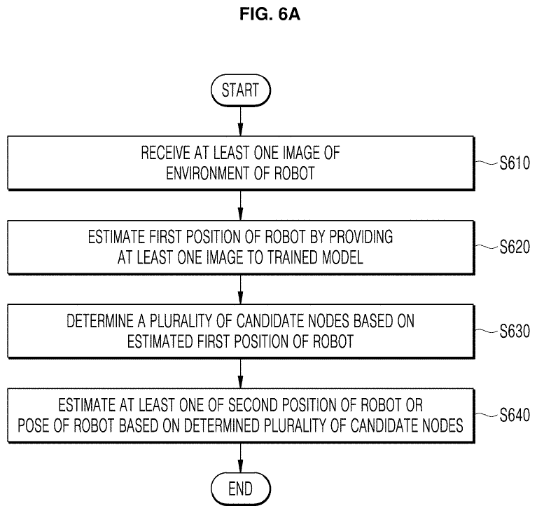

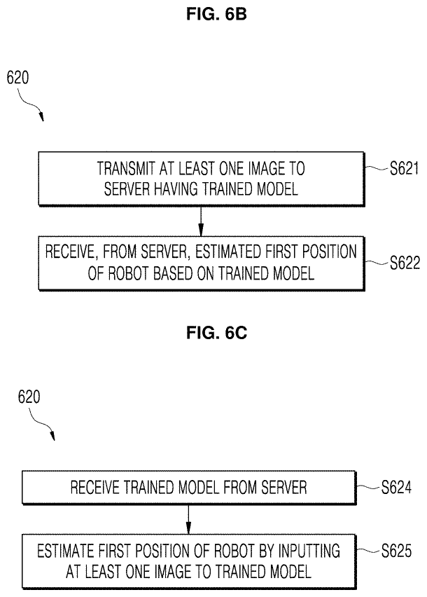

FIGS. 6A to 6C are flowcharts illustrating methods for localizing a robot according to one embodiment of the present disclosure. The methods shown in FIGS. 6A to 6C may be performed by the robot 300. In step S610, the robot 300 obtains at least one image of a surrounding environment. The at least one image may be obtained by a camera provided at the input interface 320. The at least one image may include a plurality of consecutive sequential images.

In step S620, the robot 300 estimates a first position of the robot 300 based on the obtained at least one image. The first position may represent a coarse-grained position of the robot 300. The first position may be estimated by a trained model based on an artificial neural network. The trained model may be trained to output a specific node in a map of a space or a specific position in the space, corresponding to the at least one image. A mode of operation may vary according to whether the trained model is stored in the robot 300 or the server. The server may be the control server 120 (FIG. 1) or the AI server 220 (FIG. 2).

FIG. 6B illustrates an operation based on the trained model being stored in the server. In step S621, the robot 300 transmits the obtained at least one image to the server having the trained model. The trained model of the server may output a specific node in a map of a space or a specific position in the space, corresponding to the at least one image. In step S622, the robot 300 receives a first position of the robot 300 estimated by the trained model of the server.

FIG. 6C illustrates an operation based on the trained model being stored in the robot 300. In step S624, the robot 300 receives the trained model from the server. The received trained model may be stored in the storage 380 of the robot 300. In step S625, the robot 300 estimates the first position of the robot 300 by inputting the obtained at least one image into the trained model of the storage 380.

In step S630 of FIG. 6A, the robot 300 determines candidate nodes based on the first position of the robot 300. The robot 300 may determine, as the candidate nodes, nodes within a predetermined search radius from the node indicating the first position. The range of the search radius may be stored in advance in the storage 380 of the robot 300, but may be received together with the first position from the server.

In step S640, the robot 300 estimates at least one of a second position or pose of the robot 300 based on the determined candidate nodes. The second position or pose may represent a current position or current pose of the robot 300, respectively. In an embodiment, the robot 300 may calculate a matching rate by comparing features of the at least one image with features of reference images of each of the candidate nodes. The candidate node having a highest matching rate may be determined as a final node, and a position or a pose of the final node may be estimated as the current position or current pose of the robot 300. In another embodiment, in response to the at least one image including a plurality of consecutive sequential images, the robot 300 may calculate a cumulative matching rate by sequentially comparing features of the sequential images with the features of the reference images of each of the candidate nodes. The robot 300 may determine, as the final node, a candidate node having the highest cumulative matching rate, and estimate the position or the pose of the final node as the current position or the current pose of the robot 300.

Example embodiments described above may be implemented in the form of computer programs executable through various components on a computer, and such computer programs may be recorded on computer-readable media. Examples of the computer-readable media may include, but are not limited to: magnetic medium such as hard disk, floppy disks, and magnetic tape; optical media such as CD-ROM disks and DVD-ROM disks; magneto-optical media such as floptical disks; and hardware devices that are specially configured to store and execute program instructions, such as ROM, RAM, and flash memory devices.

The computer programs may be those specially designed and constructed for the purposes of the present disclosure or they may be of the kind well known and available to those skilled in the computer software arts. Examples of computer programs may include both machine codes, such as produced by a compiler, and higher level codes that may be executed by the computer using an interpreter.

Embodiments disclosed in the present disclosure will be described in detail with reference to appended drawings, where the same or similar constituent elements are given the same reference number irrespective of their drawing symbols, and repeated descriptions thereof will be omitted. As used herein, the terms “module” and “unit” used to refer to components are used interchangeably in consideration of convenience of explanation, and thus, the terms per se should not be considered as having different meanings or functions. In addition, in describing an embodiment disclosed in the present disclosure, if it is determined that a detailed description of a related art incorporated herein unnecessarily obscure the gist of the embodiment, the detailed description thereof will be omitted. Furthermore, it should be understood that the appended drawings are intended only to help understand embodiments disclosed in the present disclosure and do not limit the technical principles and scope of the present disclosure; rather, it should be understood that the appended drawings include all of the modifications, equivalents or substitutes described by the technical principles and belonging to the technical scope of the present disclosure.

Although the terms first, second, third, and the like may be used herein to describe various elements, these elements should not be limited by these terms. These terms are generally only used to distinguish one element from another.

It will be understood that when an element is referred to as being “connected to,” “attached to,” or “coupled to” another element, it may be directly connected, attached, or coupled to the other element, or intervening elements may be present. In contrast, when an element is referred to as being “directly connected to,” “directly attached to,” or “directly coupled to” another element, no intervening elements are present.

As used in the present disclosure (especially in the appended claims), the terms “a/an” and “the” may include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

The order of individual steps in process claims according to the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example,” etc.) used herein are merely to describe the present disclosure in greater detail.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A robot comprising:
a storage configured to store a map of a space;
an input interface configured to receive at least one image of an environment of the robot; and
at least one processor configured to:
estimate a first position of the robot by providing the at least one image to a trained model based on an artificial neural network,
determine a plurality of candidate nodes in the map of the space based on the estimated first position of the robot, and
estimate at least one of a second position of the robot or a pose of the robot based on the determined plurality of candidate nodes.

2. The robot of claim 1, wherein the at least one processor is configured to:
transmit the at least one image to a server having the trained model, and
receive, from the server, the estimated first position of the robot based on the trained model.

3. The robot of claim 2, wherein the at least one processor is configured to:
determine, from the plurality of candidate nodes, specific nodes within a predetermined search radius from the estimated first position of the robot.

4. The robot of claim 3, wherein the at least one processor is configured to:
receive, from the server, information on the search radius, or
obtain, from the storage, information on the search radius.

5. The robot of claim 1, wherein the at least one processor is configured to:
determine, as a final node, a specific candidate node of the plurality of candidate nodes that has a highest matching rate with the at least one image, and
determine the second position of the robot or the pose of the robot based on a position or a pose of the final node.

6. The robot of claim 5, wherein the at least one processor is configured to:
compare at least one feature of the at least one image with features of reference images of the plurality of candidate nodes, and
determine, as the final node, the specific candidate node having the highest matching rate determined by the comparison.

7. The robot of claim 5, wherein the at least one image includes a plurality of consecutive sequential images.

8. The robot of claim 7, wherein the at least one processor is configured to:
sequentially compare features of the plurality of consecutive sequential images with features of reference images of the candidate nodes, and
determine, as the final node, the specific candidate node having the highest cumulative matching rate determined based on the sequential comparison.

9. The robot of claim 1, wherein the at least one processor is configured to:
receive, from a server, the trained model, and
estimate the first position of the robot by inputting the at least one image to the received trained model.

10. The robot of claim 1, wherein the trained model is to output, as the estimated first position, a specific position in the space or a specific node in the map of the space, corresponding to the at least one image.

11. The robot of claim 1, wherein the trained model is implemented by deep learning.

12. A method for localizing a robot comprising:
obtaining at least one image of an environment of the robot;
estimating a first position of the robot by providing the at least one image to a trained model based on an artificial neural network;
determining a plurality of candidate nodes in a map of a space, based on the estimated first position of the robot; and
estimating at least one of a second position of the robot or a pose of the robot based on the determined plurality of candidate nodes.

13. The method of claim 12, wherein the estimating of the first position of the robot comprises:
transmitting the at least one image to a server having the trained model; and
receiving, from the server, the estimated first position of the robot based on the trained model.

14. The method of claim 12, wherein the determining of the plurality of candidate nodes comprises:
determining, from the plurality of candidate nodes, specific nodes within a predetermined search radius from the estimated first position of the robot.

15. The method of claim 12, wherein the estimating of at least one of the second position of the robot or the pose of the robot comprises:
determining, as a final node, a specific candidate node of the plurality of candidate nodes that has a highest matching rate with the at least one image, and
determining the second position of the robot or the pose of the robot based on a position or a pose of the final node.

16. The method of claim 15, wherein the determining, as the final node, the specific candidate node of the plurality of candidate nodes that has the highest matching rate with the at least one image comprises:
comparing at least one feature of the at least one image with features of reference images of the plurality of candidate nodes; and
determining, as the final node, the specific candidate node having the highest matching rate determined by the comparison.

17. The method of claim 15, wherein the at least one image includes a plurality of consecutive sequential images, and
the determining, as the final node, the specific candidate node comprises:
sequentially comparing features of the plurality of consecutive sequential images with features of reference images of the candidate nodes, and
determining, as the final node, the specific candidate node having the highest cumulative matching rate determined based on the sequential comparison.

18. The method of claim 12, further comprising receiving the trained model from the server, and
wherein the estimating of the first position of the robot comprises estimating the first position of the robot by inputting the at least one image to the received trained model.

19. The method of claim 12, wherein the trained model is to output, as the estimated first position, a specific position in the space or a specific node in the map of the space, corresponding to the at least one image.

20. A computer-readable storage medium storing program code, wherein the program code, when executed, causes at least one processor to:
obtain at least one image of an environment of a robot;
estimate a first position of the robot by providing the obtained at least one image to a trained model based on an artificial neural network;
determine a plurality of candidate nodes in a map of a space, based on the estimated first position of the robot; and
estimate at least one of a second position of the robot or a pose of the robot based on the determined plurality of candidate nodes.
